(19) United States
(12) Patent Application Publication
(10) Pub. No.: US 2026/0147984 A1
(43) Pub. Date: May 28, 2026

(54) SUGGESTED EDITS ON BLOCK-BASED WORKSPACES

(71) Applicant: Notion Labs, Inc., San Francisco, CA (US)

(72) Inventors: Connie Fan, San Francisco, CA (US); Shahan Ahmed Khan, San Francisco, CA (US); Annie Yu, San Francisco, CA (US); Edmund Ian Kim, New York, NY (US); He Lu, San Francisco, CA (US); Ankit Mukherjee, San Francisco, CA (US); Yifei Shen, San Francisco, CA (US); Katherine Huang, San Francisco, CA (US)

(21) Appl. No.: 18/959,008

(22) Filed: Nov. 25, 2024

(51) Int. Cl. G06F 40/169; G06F 40/117

(52) U.S. Cl. CPC G06F 40/169; G06F 40/117

(57) ABSTRACT

A system for providing suggested edits for a block-based workspace displays content organized into multiple blocks on a workspace. Each block is associated with one or more content items. The system can enter a suggestions mode that allows users to input suggested edits or comments. While in the suggestion mode, the system can receive a suggested edit to a content item within a block, presenting it as an inline or block-level edit. The system can generate a suggestion card with a description of the edit in response to the user's input. The system can store an identifier of the suggested edit as a property of the block and display the suggested edit and suggestion card alongside the content item on the page.

### BACKGROUND

Document and productivity software tools provide editing and commenting capabilities for collaborative document review. Users can track various changes, such as insertions, deletions, and formatting adjustments, which can be shown inline, in balloons, or in a reviewing pane. The tools typically offer functions to compare and merge documents, conveniently summarizing changes and comments for easy review. Commenting features enable users to insert, reply to, and resolve comments, and these comments can be displayed or hidden as necessary. Additional functionalities include document protection through restricted editing and password security. For instance, a dedicated review or editing tab often centralizes all essential tools, including language checks. A standard workflow involves enabling a tracking function, making edits, adding comments, reviewing changes, deciding on changes, and resolving comments. These features ensure effective documentation and management of modifications and feedback, fostering collaborative editing and review.

### BRIEF DESCRIPTION OF THE DRAWINGS

Reference will now be made, by way of example, to the accompanying drawings which show example embodiments of the present application, and in which:

FIG. 1 is a block diagram illustrating a platform, which may be used to implement examples of the present disclosure.

FIG. 2 is a block diagram of a transformer neural network, which may be used in examples of the present disclosure.

FIG. 3 is a block diagram illustrating a hierarchical organization of pages in a workspace.

FIGS. 4-8 illustrate a user interface of a workspace for creating suggested edits.

FIG. 9 is a flowchart illustrating a process for creating suggested edits based on input from users of a workspace.

FIG. 10 is a flowchart illustrating a process for generating suggested edits by an artificial intelligence (AI) system.

FIG. 11 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology relates to creating or managing suggested edits in a collaborative workspace, particularly a block-based workspace. A suggested edit is a feature that allows users to propose changes to a document without directly altering the original text. An example of a suggested edit includes a recommendation or change proposed to improve the content, structure, clarity, or accuracy of a document. These edits can include corrections for grammar, punctuation, spelling, style, and formatting. This feature is useful in collaborative environments where multiple users are reviewing and editing the same document.

In one example, users of a workspace can turn on a “suggestions mode” found under a review or editing menu. Any changes made while in the suggestions mode are highlighted and marked as suggestions rather than direct edits, including insertions, deletions, and formatting changes. As such, a document owner or other collaborators can review each suggestion, which can be displayed in a different color or with a special marker to distinguish them from the original text. The document owner or designated reviewers can then accept or reject each suggested edit, incorporating the change into the document or removing the suggestion. Users can also add comments to their suggestions to provide context or explain their reasoning.

The suggested edits can be applied to content that is arranged according to a block data model, where each piece of content is treated as an individual block, allowing for a highly flexible and customizable structure. As described later, blocks can be of various types, such as text, headings, lists, images, and databases and can be nested within each other to create complex hierarchical structures. In the suggestions mode, users can reorder and move blocks via drag-and-drop functionality, and each block can be individually styled and formatted. For example, database blocks integrate seamlessly, allowing entries to contain other blocks and be viewed in multiple formats like tables and calendars. Collaboration is enhanced through suggested edits on specific blocks, and permissions are inherited from the parent page, ensuring controlled access.

In the suggestions mode, a suggested edit to block-based content can be represented as an inline edit or a block-level edit. Each edit can also be represented with a related suggestion card that includes a description of the edit and possible comments. In one example, the suggestion card is a graphical object that is presented in the margin of the document and linked to the suggested edit or located elsewhere on the document other than being inline with the content (e.g., a separate window or pane). The suggested edit has an identifier that is saved as a property of the block that includes the suggested edit. A suggested edit that spans over multiple blocks has a single identifier and is displayed as a single suggested edit on a page while being stored as a property for each of the multiple blocks that include at least a portion of the suggested edit. The suggested edits entered by users are persistent, where the identifier of a suggested edit is automatically stored as a property of one or more blocks that include at least a portion of the suggested edit. In contrast, a non-persistent suggested edit can be shown on a page but not saved in association with a block until it is converted to a persistent suggested edit.

An example workflow involves enabling suggestions mode, collaboratively making changes that appear as suggestions in the block-based data, reviewing the suggestions, and then accepting or rejecting them. Optionally, users can add comments to explain their suggested changes. The suggested edits allow for non-destructive editing because the original text remains intact until suggestions are accepted/rejected, and collaboration by multiple users without overwriting each other's work.

Another aspect of the disclosed technology includes suggested edits that are generated by an artificial intelligence (AI) system. However, unlike suggested edits that are entered manually to a page by a user, suggested edits generated by an AI for a particular document can be voluminous. The suggested edits that are generated by AI are rendered as non-persistent edits on a page. As such, a suggested edit that is generated by an AI system is not automatically stored in association with one or more blocks that include at least a portion of the suggested edit. Instead, an authorized user would need to perform an additional action to make the edit persistent, such that an identifier of the suggested edit is stored as a property of the block that includes at least a portion of the suggested edit. In one example, a preview of the AI-suggested edits is shown directly integrated into the original text to show the suggested changes, but such suggested edits are not saved as properties of the page until a user accepts the suggested edits.

The technology can enable a combination of user-suggested edits and AI-suggested edits in a manner that reduces undesired noisiness caused by AI. As a result, for example, when a page is closed, non-accepted AI-suggested edits are discarded while accepted AI-suggested edits and user-suggested edits are saved. Accordingly, user-suggested edits are treated as persistent (e.g., saved as a property of an associated page), while AI-suggested edits are treated as non-persistent until they are accepted by a user.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Block Data Model

The disclosed technology includes a block data model (“block model”). The blocks are dynamic units of information that can be transformed into other block types and move across workspaces. The block model allows users to customize how their information is moved, organized, and shared. Hence, blocks contain information but are not siloed.

Blocks are singular pieces that represent all units of information inside an editor. In one example, text, images, lists, a row in a database, etc., are all blocks in a workspace. The attributes of a block determine how that information is rendered and organized. Every block can have attributes including an identifier (ID), properties, and type. Each block is uniquely identifiable by its ID. The properties can include a data structure containing custom attributes about a specific block. An example of a property is “title,” which stores text content of block types such as paragraphs, lists, and the title of a page. More elaborate block types require additional or different properties, such as a page block in a database with user-defined properties. Every block can have a type, which defines how a block is displayed and how the block's properties are interpreted.

A block has attributes that define its relationship with other blocks. For example, the attribute “content” is an array (or ordered set) of block IDs representing the content inside a block, such as nested bullet items in a bulleted list or the text inside a toggle. The attribute “parent” is the block ID of a block's parent, which can be used for permissions. Blocks can be combined with other blocks to track progress and hold all project information in one place.

A block type is what specifies how the block is rendered in a user interface (UI), and the block's properties and content are interpreted differently depending on that type. Changing the type of a block does not change the block's properties or content—it only changes the type attribute. The information is thus rendered differently or even ignored if the property is not used by that block type. Decoupling property storage from block type allows for efficient transformation and changes to rendering logic and is useful for collaboration.

Blocks can be nested inside of other blocks (e.g., infinitely nested sub-pages inside of pages). The content attribute of a block stores the array of block IDs (or pointers) referencing those nested blocks. Each block defines the position and order in which its content blocks are rendered. This hierarchical relationship between blocks and their render children are referred to herein as a “render tree.” In one example, page blocks display their content in a new page, instead of rendering it indented in the current page. To see this content, a user would need to click into the new page.

In the block model, indentation is structural (e.g., reflects the structure of the render tree). In other words, when a user indents something, the user is manipulating relationships between blocks and their content, not just adding a style. For example, pressing Indent in a content block can add that block to the content of the nearest sibling block in the content tree.

Blocks can inherit permissions of blocks in which they are located (which are above them in the tree). Consider a page: to read its contents, a user must be able to read the blocks within that page. However, there are two reasons one cannot use the content array to build the permissions system. First, blocks are allowed to be referenced by multiple content arrays to simplify collaboration and a concurrency model. But because a block can be referenced in multiple places, it is ambiguous which block it would inherit permissions from. The second reason is mechanical. To implement permission checks for a block, one needs to look up the tree, getting that block's ancestors all the way up to the root of the tree (which is the workspace). Trying to find this ancestor path by searching through all blocks'content arrays is inefficient, especially on the client. Instead, the model uses an “upward pointer”—the parent attribute—for the permission system. The upward parent pointers and the downward content pointers mirror each other.

A block's life starts on the client. When a user takes an action in the interface—typing in the editor, dragging blocks around a page—these changes are expressed as operations that create or update a single record. The “records” refer to persisted data, such as blocks, users, workspaces, etc. Because many actions usually change more than one record, operations are batched into transactions that are committed (or rejected) by the server as a group.

Creating and updating blocks can be performed by, for example, pressing Enter on a keyboard. First, the client defines all the initial attributes of the block, generating a new unique ID, setting the appropriate block type (to_do), and filling in the block's properties (an empty title, and checked: [[“No”]]). The client builds operations to represent the creation of a new block with those attributes. New blocks are not created in isolation: blocks are also added to their parent's content array, so they are in the correct position in the content tree. As such, the client also generates an operation to do so. All these individual change operations are grouped into a transaction. Then, the client applies the operations in the transaction to its local state. New block objects are created in memory and existing blocks are modified. In native apps, the model caches all records that are accessed locally in an LRU (least recently used) cache on top of SQLite or IndexedDB, referred to as RecordCache. When records are changed on a native app, the model also updates the local copies in RecordCache. The editor re-renders to draw the newly created block onto the display. At the same time, the transaction is saved into TransactionQueue, the part of the client responsible for sending all transactions to the model's servers so that the data is persisted and shared with collaborators. TransactionQueue stores transactions safely in IndexedDB or SQLite (depending on the platform) until they are persisted by the server or rejected.

A block can be saved on a server to be shared with others. Usually, TransactionQueue sits empty, so the transaction to create the block is sent to the server in an application programming interface (API) request. In one example, the transaction data is serialized to JSON and posted to the /saveTransactions API endpoint. SaveTransactions gets the data into source-of-truth databases, which store all block data as well as other kinds of persisted records. Once the request reaches the API server, all the blocks and parents involved in the transaction are loaded. This gives a “before” picture in memory. The block model duplicates the “before” data that had just been loaded in memory. Next, the block model applies the operations in the transaction to the new copy to create the “after” data. Then the model uses both “before” and “after” data to validate the changes for permissions and data coherency. If everything checks out, all created or changed records are committed to the database—meaning the block has now officially been created. At this point, a “success” HTTP response to the original API request is sent by the client. This confirms that the client knows the transaction was saved successfully and that it can move on to saving the next transaction in the TransactionQueue. In the background, the block model schedules additional work depending on the kind of change made for the transaction. For example, the block model can schedule version history snapshots and indexing block text for a Quick Find function. The block model also notifies MessageStore, which is a real-time updates service, about the changes that were made.

The block model provides real-time updates to, for example, almost instantaneously show new blocks to members of a teamspace. Every client can have a long-lived WebSocket connection to the MessageStore. When the client renders a block (or page, or any other kind of record), the client subscribes to changes of that record from MessageStore using the WebSocket connection. When a team member opens the same page, the member is subscribed to changes of all those blocks. After changes have been made through the saveTransactions process, the API notifies MessageStore of new recorded versions. MessageStore finds client connections subscribed to those changing records and passes on the new version through their WebSocket connection. When a team member's client receives version update notifications from MessageStore, it verifies that version of the block in its local cache. Because the versions from the notification and the local block are different, the client sends a syncRecordValues API request to the server with the list of outdated client records. The server responds with the new record data. The client uses this response data to update the local cache with the new version of the records, then re-renders the user interface to display the latest block data.

Blocks can be shared instantaneously with collaborators. In one example, a page is loaded using only local data. On the web, block data is pulled from being in memory. On native apps, loading blocks that are not in memory are loaded from the RecordCache persisted storage. However, if missing block data is needed, the data is requested from an API. The API method for loading the data for a page is referred to herein as loadPageChunk; it descends from a starting point (likely the block ID of a page block) down the content tree and returns the blocks in the content tree plus any dependent records needed to properly render those blocks. Several layers of caching for loadPageChunk are used, but in the worst case, this API might need to make multiple trips to the database as it recursively crawls down the tree to find blocks and their record dependencies. All data loaded by loadPageChunk is put into memory (and saved in the RecordCache if using the app). Once the data is in memory, the page is laid out and rendered using React.

### Software Platform

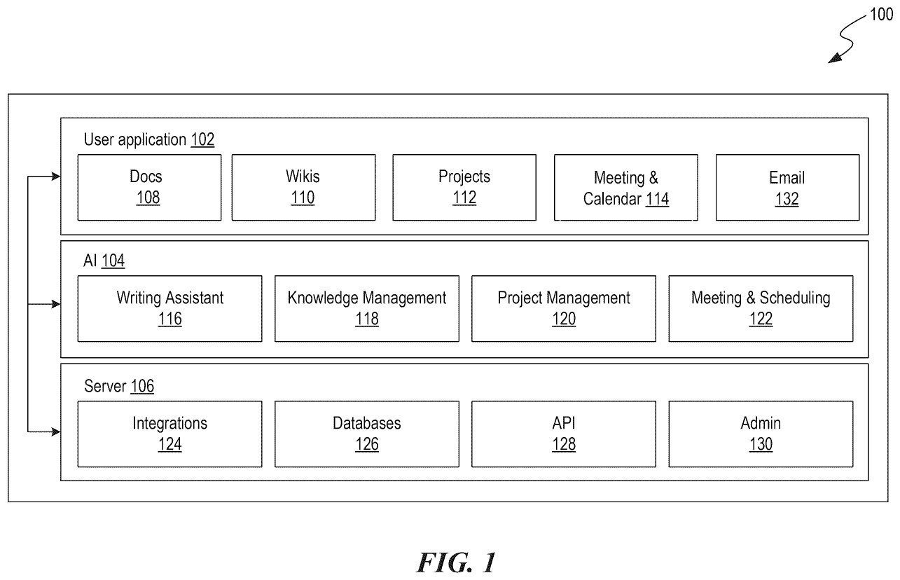

FIG. 1 is a block diagram of an example platform 100. The platform 100 provides users with an all-in-one workspace for data and project management. The platform 100 can include a user application 102, an AI tool 104, and a server 106. The user application 102, the AI tool 104, and the server 106 are in communication with each other via a network.

In some implementations, the user application 102 is a cross-platform software application configured to work on several computing platforms and web browsers. The user application 102 can include a variety of templates. A template refers to a prebuilt page that a user can add to a workspace within the user application 102. The templates can be directed to a variety of functions. Exemplary templates include a docs template 108, a wikis template 110, a projects template 112, a meeting and calendar template 114, and an email template 132. In some implementations, a user can generate, save, and share customized templates with other users.

The user application 102 templates can be based on content “blocks.” For example, the templates of the user application 102 include a predefined and/or pre-organized set of blocks that can be customized by the user. Blocks are content containers within a template that can include text, images, objects, tables, maps, emails, and/or other pages (e.g., nested pages or sub-pages). Blocks can be assigned to certain properties. The blocks are defined by boundaries having dimensions. The boundaries can be visible or non-visible for users. For example, a block can be assigned as a text block (e.g., a block including text content), a heading block (e.g., a block including a heading) or a sub-heading block having a specific location and style to assist in organizing a page. A block can be assigned as a list block to include content in a list format. A block can be assigned as an AI prompt block (also referred to as a “prompt block”) that enables a user to provide instructions (e.g., prompts) to the AI tool 104 to perform functions. A block can also be assigned to include audio, video, or image content.

A user can add, edit, and remove content from the blocks. The user can also organize the content within a page by moving the blocks around. In some implementations, the blocks are shared (e.g., by copying and pasting) between the different templates within a workspace. For example, a block embedded within multiple templates can be configured to show edits synchronously.

The docs template 108 is a document generation and organization tool that can be used for generating a variety of documents. For example, the docs template 108 can be used to generate pages that are easy to organize, navigate, and format. The wikis template 110 is a knowledge management application having features similar to the pages generated by the docs template 108 but that can additionally be used as a database. The wikis template 110 can include, for example, tags configured to categorize pages by topic and/or include an indication of whether the provided information is verified to indicate its accuracy and reliability. The projects template 112 is a project management and note-taking software tool. The projects template 112 can allow the users, either as individuals or as teams, to plan, manage, and execute projects in a single forum. The meeting and calendar template 114 is a tool for managing tasks and timelines. In addition to traditional calendar features, the meeting and calendar template 114 can include blocks for categorizing and prioritizing scheduled tasks, generating to-do and action item lists, tracking productivity, etc. The various templates of the user application 102 can be included under a single workspace and include synchronized blocks. For example, a user can update a project deadline on the projects template 112, which can be automatically synchronized to the meeting and calendar template 114. The various templates of the user application 102 can be shared within a team, allowing multiple users to modify and update the workspace concurrently.

The email template 132 allows the users to customize their inbox by representing the inbox as a customizable database where the user can add custom columns and create custom views with layouts. One view can include multiple layouts including a calendar layout, a summary layout, and urgent information layout. Each view can include a customized structure including custom criteria, custom properties, and custom actions. The custom properties can be specific to a view such as artificial intelligence-extracted properties, and/or heuristic-based properties. The custom actions can trigger automatically when a message enters the view. The custom actions can include deterministic rules like “Archive this,” or assistant workflows like responding to support messages by searching user applications 102 or filing support tickets. In addition, the view can include actions, such as buttons, that are custom to the view and perform operations on the messages in the inbox. Only the customized structure can be shared with other users of the system, or both the customized structure and the messages can be shared.

The integration of the docs template 108, the wikis template 110, the projects template 112, the meeting and calendar template 114, and the email template 132 enables linking and embedding of templates within other templates. For example, an email sent from an email address within the platform 100 to another email address within the platform 100, can include an embedding of a document within the platform 100, or an embedding of a block in the document. In another example, a wiki can link to a meeting within the calendar.

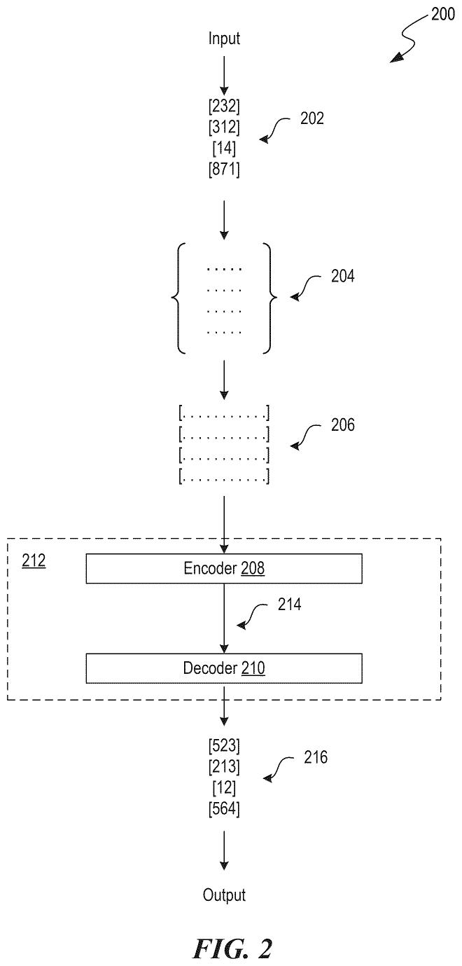

The AI tool 104 is an integrated AI assistant that enables AI-based functions for the user application 102. In one example, the AI tool 104 is based on a neural network architecture, such as the transformer 212 described in FIG. 2. The AI tool 104 can interact with blocks embedded within the templates on a workspace of the user application 102. For example, the AI tool 104 can include a writing assistant tool 116, a knowledge management tool 118, a project management tool 120, and a meeting and scheduling tool 122. The different tools of the AI tool 104 can be interconnected and interact with different blocks and templates of the user application 102.

The writing assistant tool 116 can operate as a generative AI tool for creating content for the blocks in accordance with instructions received from a user. Creating the content can include, for example, summarizing, generating new text, or brainstorming ideas. For example, in response to a prompt received as a user input that instructs the AI to describe what the climate is like in New York, the writing assistant tool 116 can generate a block including a text that describes the climate in New York. As another example, in response to a prompt that requests ideas on how to name a pet, the writing assistant tool 116 can generate a block including a list of creative pet names. The writing assistant tool 116 can also operate to modify existing text. For example, the writing assistant can shorten, lengthen, or translate existing text, correct grammar and typographical errors, or modify the style of the text (e.g., a social media style versus a formal style).

The knowledge management tool 118 can use AI to categorize, organize, and share knowledge included in the workspace. In some implementations, the knowledge management tool 118 can operate as a question-and-answer assistant. For example, a user can provide instructions on a prompt block to ask a question. In response to receiving the question, the knowledge management tool 118 can provide an answer to the question, for example, based on information included in the wikis template 110. The project management tool 120 can provide AI support for the projects template 112. The AI support can include auto filling information based on changes within the workspace or automatically track project development. For example, the project management tool 120 can use AI for task automation, data analysis, real-time monitoring of project development, allocation of resources, and/or risk mitigation. The meeting and scheduling tool 122 can use AI to organize meeting notes, unify meeting records, list key information from meeting minutes, and/or connect meeting notes with deliverable deadlines.

The server 106 can include various units (e.g., including compute and storage units) that enable the operations of the AI tool 104 and workspaces of the user application 102. The server 106 can include an integrations unit 124, an application programming interface (API) 128, databases 126, and an administration (admin) unit 130. The databases 126 are configured to store data associated with the blocks. The data associated with the blocks can include information about the content included in the blocks, the function associated with the blocks, and/or any other information related to the blocks. The API 128 can be configured to communicate the block data between the user application 102, the AI tool 104, and the databases 126. The API 128 can also be configured to communicate with remote server systems, such as AI systems. For example, when a user performs a transaction within a block of a template of the user application 102 (e.g., in a docs template 108), the API 128 processes the transaction and saves the changes associated with the transaction to the database 126. The integrations unit 124 is a tool connecting the platform 200 with external systems and software platforms. Such external systems and platforms can include other databases (e.g., cloud storage spaces), messaging software applications, or audio or video conference applications. The administration unit 130 is configured to manage and maintain the operations and tasks of the server 106. For example, the administration unit 130 can manage user accounts, data storage, security, performance monitoring, etc.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification, etc.) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online webpages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses LLMs.

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 2 is a block diagram of an example transformer 212. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as recurrent neural network (RNN)-based language models.

The transformer 212 includes an encoder 208 (which can include one or more encoder layers/blocks connected in series) and a decoder 210 (which can include one or more decoder layers/blocks connected in series). Generally, the encoder 208 and the decoder 210 each include multiple neural network layers, at least one of which can be a self-attention layer. The parameters of the neural network layers can be referred to as the parameters of the language model.

The transformer 212 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 212 is trained to perform certain functions on other input formats than natural language input. For example, the input can include objects, images, audio content, or video content, or a combination thereof.

The transformer 212 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 2 illustrates an example of how the transformer 212 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 2, a short sequence of tokens 202 corresponding to the input text is illustrated as input to the transformer 212. Tokenization of the text sequence into the tokens 202 can be performed by some pre-processing tokenization module such as, for example, a byte-pair encoding tokenizer (the “pre” referring to the tokenization occurring prior to the processing of the tokenized input by the LLM), which is not shown in FIG. 2 for brevity. In general, the token sequence that is inputted to the transformer 212 can be of any length up to a maximum length defined based on the dimensions of the transformer 212. Each token 202 in the token sequence is converted into an embedding vector 206 (also referred to as “embedding 206”).

An embedding 206 is a learned numerical representation (such as, for example, a vector) of a token that captures some semantic meaning of the text segment represented by the token 202. The embedding 206 represents the text segment corresponding to the token 202 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 206 corresponding to the “write” token will be closer to another embedding corresponding to the “jot down” token in the vector space as compared to the distance between the embedding 206 corresponding to the “write” token and another embedding corresponding to the “summary” token.

The vector space can be defined by the dimensions and values of the embedding vectors. Various techniques can be used to convert a token 202 to an embedding 206. For example, another trained ML model can be used to convert the token 202 into an embedding 206. In particular, another trained ML model can be used to convert the token 202 into an embedding 206 in a way that encodes additional information into the embedding 206 (e.g., a trained ML model can encode positional information about the position of the token 202 in the text sequence into the embedding 206). In some implementations, the numerical value of the token 202 can be used to look up the corresponding embedding in an embedding matrix 204, which can be learned during training of the transformer 212.

The generated embeddings 206 are input into the encoder 208. The encoder 208 serves to encode the embeddings 206 into feature vectors 214 that represent the latent features of the embeddings 206. The encoder 208 can encode positional information (i.e., information about the sequence of the input) in the feature vectors 214. The feature vectors 214 can have very high dimensionality (e.g., on the order of thousands or tens of thousands), with each element in a feature vector 214 corresponding to a respective feature. The numerical weight of each element in a feature vector 214 represents the importance of the corresponding feature. The space of all possible feature vectors 214 that can be generated by the encoder 208 can be referred to as a latent space or feature space.

Conceptually, the decoder 210 is designed to map the features represented by the feature vectors 214 into meaningful output, which can depend on the task that was assigned to the transformer 212. For example, if the transformer 212 is used for a translation task, the decoder 210 can map the feature vectors 214 into text output in a target language different from the language of the original tokens 202. Generally, in a generative language model, the decoder 210 serves to decode the feature vectors 214 into a sequence of tokens. The decoder 210 can generate output tokens 216 one by one. Each output token 216 can be fed back as input to the decoder 210 in order to generate the next output token 216. By feeding back the generated output and applying self-attention, the decoder 210 can generate a sequence of output tokens 216 that has sequential meaning (e.g., the resulting output text sequence is understandable as a sentence and obeys grammatical rules). The decoder 210 can generate output tokens 216 until a special [EOT] token (indicating the end of the text) is generated. The resulting sequence of output tokens 216 can then be converted to a text sequence in post-processing. For example, each output token 216 can be an integer number that corresponds to a vocabulary index. By looking up the text segment using the vocabulary index, the text segment corresponding to each output token 216 can be retrieved, the text segments can be concatenated together, and the final output text sequence can be obtained.

In some implementations, the input provided to the transformer 212 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API (e.g., the API 128 in FIG. 1). As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Hierarchical Organizational Blocks in a Workspace

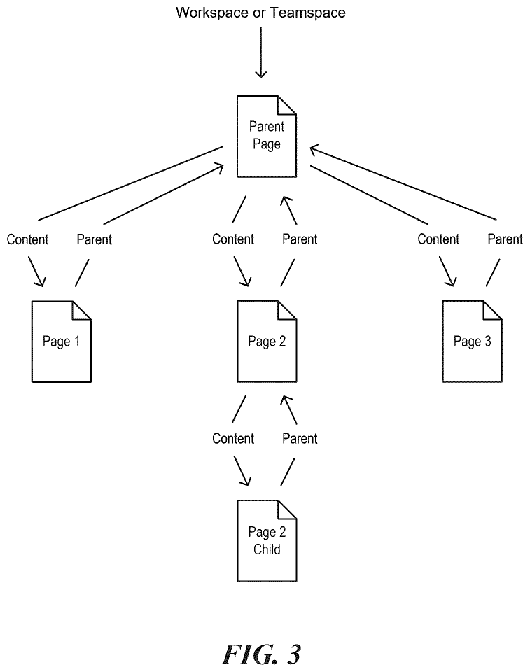

FIG. 3 is a block diagram illustrating a hierarchical organization of pages in a workspace. As described with respect to the block data model of the present technology, a workspace can include multiple pages (e.g., page blocks). The pages (e.g., including parent pages and child or nested pages) can be arranged hierarchically within the workspace or one or more teamspaces, as shown in FIG. 3. The page can include a block such as tabs, lists, images, tables, etc.

A teamspace can refer to a collaborative space associated with a team or an organization that is hierarchically below a workspace. For example, a workspace can include a teamspace accessible by all users of an organization and multiple teamspaces that are accessible by users of different teams. Accessibility generally refers to creating, editing, and/or viewing content (e.g., pages) included in the workspace or the one or more teamspaces.

In the hierarchical organization illustrated in FIG. 3, a parent page (e.g., “Parent Page”) is located hierarchically below the workspace or a teamspace. The parent page includes three children pages (e.g., “Page 1,” “Page 2,” and “Page 3”). Each of the child pages can further include subpages (e.g., “Page 2 Child” which is a grandchild of “Parent Page” and child of “Page 2”). The “Content” arrows in FIG. 3 indicate the relationship between the parents and children while the “Parent” arrows indicate the inheritance of access permissions. The child pages inherit access permission from the (immediate) parent page under which they are located hierarchically (e.g., which is above them in the tree). For example, “Page 2” inherited the access permission of the “Parent page” as a default when it was created under its parent page. Similarly, “Page 2 Child” inherited the access permission of the parent page as a default when it was created under its parent page. “Parent Page,” “Page 2,” and “Page 2 Child” thereby have the same access permission within the workspace.

The relationships and organization of the content can be modified by changing the location of the pages. For example, when a child page is moved to be under a different parent, the child page's access permission modifies to correspond to the access permission of the new parent. Also, when the access permission of “Parent Page” is modified, the access permission of “Page 1,” “Page 2,” and “Page 3” can be automatically modified to correspond to the access permission of “Parent Page” based on the inheritance character of access permissions.

In contrast, however, a user can modify the access permission of the children independently of their parents. For example, the user can modify the access permission of “Page 2 Child” in FIG. 3 so that it is different from the access permission of “Page 2” and “Parent Page.” The access permission of “Page 2 Child” can be modified to be broader or narrower than the access permission of its parents. As an example, “Page 2 Child” can be shared on the internet while “Page 2” is only shared internally to the users associated with the workspace. As another example, “Page 2 Child” can be shared only with an individual user while “Page 2” is shared with a group of users (e.g., a team of the organization associated with the workspace). In some implementations, the hierarchical inheritance of the access permissions described herein can be modified from the previous description. For example, the access permissions of all the pages (parent and children) can be defined as independently changeable.

### Suggested Edits

The disclosed technology addresses issues in collaborative document editing including the necessity for a unified system that allows users to view and respond to suggestions from both human contributors and AI systems. Traditional text-centric methods often fail to provide a cohesive experience for integrating suggestions from numerous sources. Users struggle to manage and differentiate between human and AI-generated suggestions, resulting in inefficiencies and potential errors in the editing process. This challenge is particularly pronounced in environments where real-time collaboration and content accuracy are crucial, such as professional and creative settings.

The disclosed system integrates user-suggested and AI-suggested edits into a block-based framework. This system enables blocks to be modified using a suggestions model that supports both human and AI input through the same visual interface. For human suggestions, the system extends the existing comments functionality, allowing users to propose changes directly within the page. AI suggestions are presented using an inline diffing model, seamlessly integrating them into the original text. This unified approach enhances user experience by providing a consistent and intuitive interface while streamlining content management. The system ensures that AI-suggested edits are only saved if accepted by the user, whereas user-suggested edits are preserved as properties of the blocks of the page, maintaining the document's integrity and accuracy. This solution support integrations with advanced technologies like Natural Language Processing (NLP) of suggested edits, which can be used to generate suggested edits by the AI system. For example, the AI system can include a chatbot that responds to NLP inputs to generated suggested edits.

The system offers several advantages over traditional text-centric methods. First, it employs a block model approach, which is more flexible and intuitive for users. This model allows for granular control over edits to text and media, as well as block-based edits, making it easier to manage and integrate suggestions from multiple sources. By using a unified visual interface for both human and AI suggestions, the system reduces users'cognitive load, enabling them to focus on content quality rather than navigating complex editing tools. The system also includes a notification mechanism to alert reviewers of new suggestions, ensuring edits are promptly addressed. This approach not only enhances efficiency but also improves the accuracy and reliability of the final page.

The system operates through a suggestions mode where content edits are represented as either inline or block-level changes, for example. In one example, each suggested edit is associated with a suggestion card that includes a description and possible comments, providing context and rationale for the proposed change. AI-suggested edits are displayed integrated into the original text but are not saved unless explicitly accepted by the user. This ensures that only vetted changes are incorporated into the document, preserving its integrity. Non-accepted AI suggestions are discarded when the page is closed, for example, while user-suggested edits are stored as properties of blocks of the page, ensuring they are preserved for future reference.

The system includes updates to block and discussion data models to support the suggestions functionality. In particular, the block data model is a flexible framework that organizes content into discrete blocks. Each block can contain text, images, or other media, and can be individually edited, moved, or deleted. This model supports granular control over document changes, allowing for both inline and block-level edits. It integrates with the discussion data model, enabling each block to have associated suggestion cards and discussions.

The discussion data model is a structured framework that manages and organizes discussions, comments, and feedback related to suggested edits within a page. It integrates with the block model, allowing each block to have associated suggestion cards and discussions. The model supports both inline and block-level edits, tracking the status of each suggestion (e.g., accepted, rejected, pending review) and storing user comments and feedback. It includes user roles and permissions to control access and visibility, and a notification system to alert users of new suggestions or comments.

Thus, the updated block data model offers improved management of edits at both inline and block levels, with suggestion cards for changes and feedback. It tracks the status of suggestions and integrates with a discussion model for collaborative reviews. Notifications alert users to new suggestions or comments, improving page management efficiency. Further, the discussion data model includes suggestion cards for each edit, status tracking, and an enhanced commenting system. The updates to both models manage user roles, permissions, and notifications, ensuring structured data storage and retrieval, thereby enhancing collaboration.

New editor annotations are introduced to represent suggested edits within the page, providing a visual indication of proposed changes and their status (e.g., accepted, rejected, pending). The editor annotations handle suggested edits, and the user interface is modified to display and manage these annotations effectively. The design ensures that both human and AI suggestions are presented consistently and intuitively, making it easy for users to navigate and resolve suggestions. Further, the notification mechanism alerts reviewers of new suggestions, ensuring that edits are promptly addressed and incorporated into the page as needed.

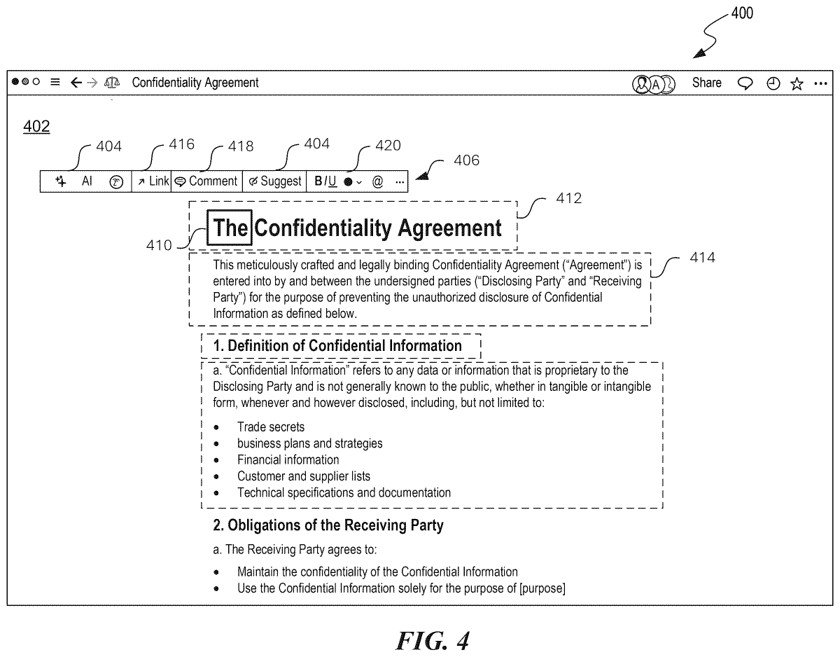

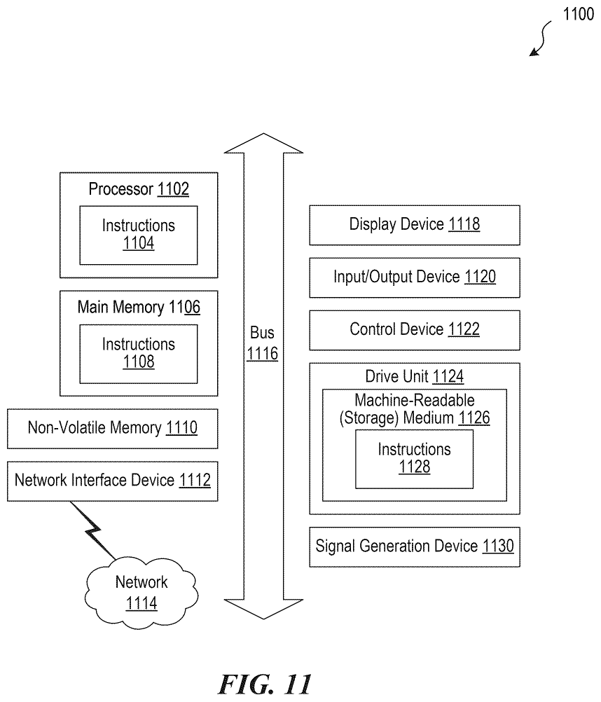

FIGS. 4-8 illustrate a user interface 400 of a workspace for creating suggested edits. The workspace can be associated with the platform 100 described with respect to FIG. 1. The user interface 400 includes a page (e.g., a page block) including multiple content and title blocks (e.g., a title block 412 and a content block 414). In FIG. 4, the page 402 is in a mode that allows a user to review and edit the content of the page such that all edits are incorporated and shown on the page 402 without any indications for the edits. Edits can include adding content (e.g., text or objects), removing content, or editing existing content. The edits can be done based on a user input received from a user. A user input (or an input) can include, for example, a click, a drag, a tap, a double click, text input, or a combination thereof provided via a user input device or a control device (e.g., an input/output device 1120 or a control device 1122 in FIG. 11) when a cursor or a caret is positioned on a desired location of the page 402.

In some implementations, the user may provide an input on the page or directed to all or a portion of the content on the page to display a toolbar 406. As an example, in FIG. 4, a user has provided an input (e.g., a double click or a left click by a mouse) while a cursor is positioned on a portion of content (e.g., a content portion 410 including the word “The” on the title block 412). In response to the input, the content portion 410 is highlighted and the toolbar 406 is displayed providing a variety of control elements for editing the content of the page 402. A control element refers to a visual element on a graphical user interface that is associated with a particular action or interaction performed in response to receiving an input on the control element. In some implementations, a control element is selectable so that a user can provide an input (e.g., a click input) to select to perform the action associated with the control element. In some implementations, a control element includes a text field that allows a user to input text inside the control element.

As examples, an AI control element 404 enables a user to open an integrated AI tool (e.g., the AI tool 104 in FIG. 1), a link control element 416 enables a user to create a link (e.g., a Uniform Resource Locator (URL) link) connecting content to the content portion 410, a comment control element 418 enables a user to provide a comment associated with the content portion 410 (e.g., a comment displayed on the page 402) and edit control element 420 enables a user to edit the content portion 410 (e.g., by adding special characters or objects, or editing font style).

In some instances, a user may wish to provide suggested edits rather than just editing the content. For example, a user is editing content created by another user and wants to provide his or her feedback and suggestions for improving the content for consideration by the content-creator user. As another example, a user is editing content he or her has created but wishes to leave suggested edits for further consideration. In such instances, a user may wish to enter a suggestion mode that allows the user to provide suggested edits. A user can provide an input (e.g., a click) on a suggestion mode control element 404 which can enable the page 402 to enter a suggestion mode. The suggestion mode can enable certain features to be available for a user related to providing suggested edits. The suggestion mode can be available to all users that have access to the page 402 or be limited to users authorized by an administrator user associated with the workspace or another user such as a content creator.

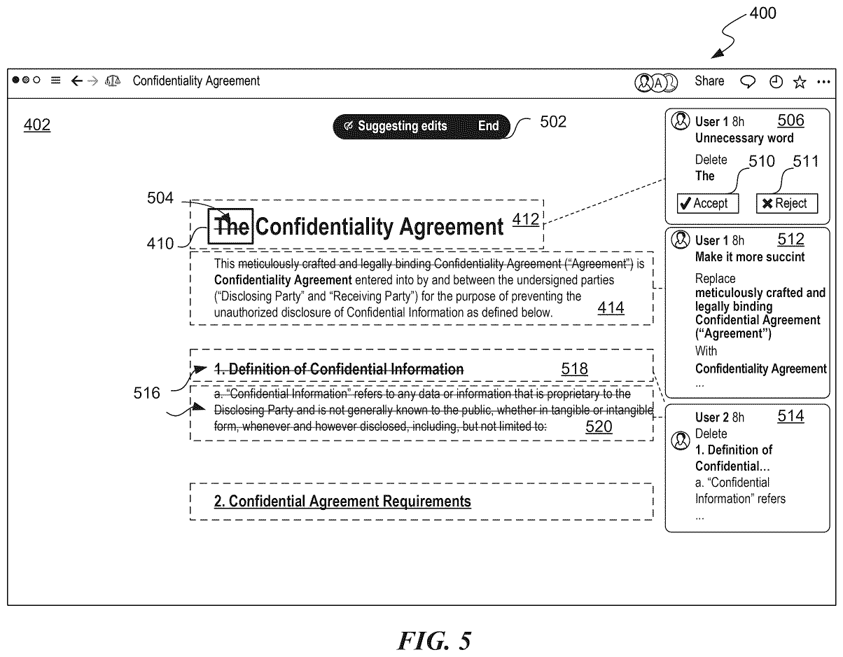

FIG. 5 illustrates the page 402 in a suggested mode, as demonstrated by an indicator 502. A user can exit the suggestion mode of page 402 by clicking a control element on the indicator 502 (e.g., a control element “End”). FIG. 5 further illustrates multiple suggested edits provided on the content on the page 402 (shown with overstrikes and underlines on the text of page 402) as well as multiple suggestion cards (e.g., suggestion cards, 506, 512, 514, and 516). The suggestions on page 402 can include suggestions by multiple different users (e.g., user 1 and user 2). The suggestions on page 402 can further include suggestions made by an AI tool or an AI assistant (e.g., the AI tool 104 in FIG. 1). Each of the suggestion cards is associated with a suggested edit on the content of page 402.

The suggestion card 506 is associated with a suggested edit on the title block 412 (e.g., as illustrated with a dashed line). The suggested edit includes a suggested edit 504 to remove the content portion 410 (e.g., the word “The”). The suggestion card 506 is generated in response to an input by User 1 (e.g., a user associated with a workspace account for User 1). The suggestion card 506 includes a description of the suggested edit 504 (e.g. “Delete The” and a possible explanation or reasoning provided by User 1 (e.g., “Unnecessary word”). The suggestion card further includes control elements of accepting and rejecting the suggested edit (e.g., an accept control element 510 and a reject control element 511). The suggested edit can be accepted or rejected. In some implementations, an accepted suggested edit can be modified to appear as part of the non-edited content. Alternatively, in some implementations, an accepted edit is indicated with a visual feature (e.g., a color, a shading, a pattern). A user can provide an input to see the suggestion card associated with the accepted edit, including the edit that has been made and the explanation and reasoning for the change. Similarly, a rejected edit can be removed (e.g., the content is displayed as it appeared before the suggested edit) or the rejected edit can be indicated with a visual feature different from the visual feature used to indicated accepted suggested edits. A user can review the suggestion card by providing an input on the portion of the page where the rejected edit was positioned. Similarly, the suggestion card 512 is associated with the text replacement suggested edit in the content block 414. The suggestion card 512 includes a description of the suggested replacement edit and an explanation or reasoning for the suggested edit, as described with respect to the suggestion card 506).

The suggested edits to a block, including those to the title block 412 and the content block 414, and information on an associated suggestion card (e.g., the suggestions cards 506 and 512, respectively), can be stored by the system as properties of the respective block. The storing can include creating and storing a unique identifier associated with a suggested edit as a property of the respective block. The principles of blocks and block properties are described in detail in the Block Data Model section. In some implementations, the suggested edits are at a content level. Content level suggested mode edits can be illustrated as inline suggested edits (e.g., as shown for blocks 412 and 414). The suggested additions, deletions, or any other modifications can be indicated with a desired style. For example, deletions are indicated with overstrike and additions with underline. Alternatively, different colors, patterns, shadings, boxes around words, etc., can be used as indicators for suggested edits.

In some implementations, a single suggested edit can include suggested edits to two or more blocks. In FIG. 5, User 2 has provided an input for suggested edit 516 to delete the content of the blocks 518 and 520. A suggested edit crossing over two or more blocks is associated with a single suggestion card. For example, the suggestion card 514 is associated with the suggested edit 516 for content in blocks 518 and 520. The suggested edit 516 and the information of the suggestion card 514 are stored as a property of both of the blocks 518 and 520.

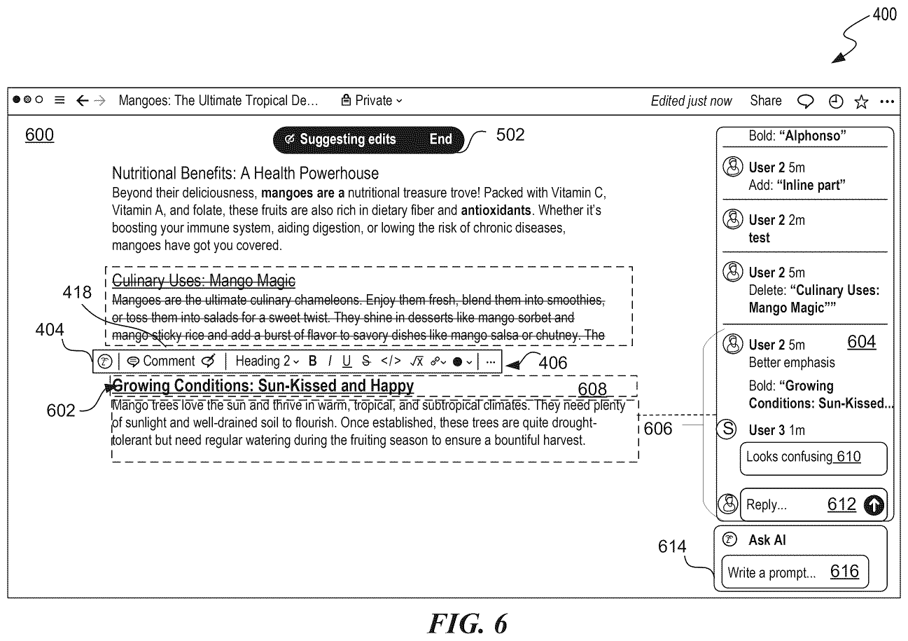

FIG. 6 illustrates the user interface 400 including a page 600 of the workspace. The page 600 is in the suggestion mode, as illustrated by indicator 502. The page 600 includes multiple blocks including text content, as shown. The page 600 illustrates an implementation where suggestion cards (e.g., a suggestion card 604) associated with suggested edits (e.g., a suggested edit 602 to content of a title block 608) can be integrated with a discussion data model.

A discussion data model can be configured to manage and organize discussions, comments, and feedback input by users of the workspace. The discussion model involves with various elements of a discussion, such as participants, topics, comments, and timestamps, to ensure a comprehensive and traceable dialogue. The elements of a discussion are stored based on the block data model described in the Block Data Model section. For example, a discussion can be stored as a block. Additionally, the discussion block can be included in, or be linked to (e.g., by a pointer) a block associated with a suggestion card and/or a block including the suggested edit. For example, a discussion block, a suggestion card, and a suggested edit can all be associated with respective unique identifiers and stored as a property of the content block.

In FIG. 6, User 2 has provided the suggested edit 602 on the title block 608 to change the style (i.e., to bold) the style of a portion of the text of the title block 608. User 2 has provided a reasoning “Better Emphasis” on the suggestion card 604 associated with the suggested edit 602. User 3 has then provided a comment 610 (“Looks confusing”) on the suggestion card 604 thereby integrating a discussion section 606 into the suggestion card 604. The comment can be added, for example, via the comment control element 418 of the toolbar 406, as described with respect to FIG. 4. The discussion section can further automatically include a reply control element 612 that allows User 2 or any user to provide a comment to continue the discussion.

In some implementations, the suggested edits can be provided by an integrated AI tool. As described above with respect to FIG. 4, the AI control element 404 can enable a user to open an integrated AI tool (e.g., the AI tool 104 in FIG. 1). In FIG. 6, in response to a user input on the AI control element 404, the page 600 displays an AI tool 614 including a prompt control element 616. The prompt control element 616 can enable a user to provide a text input (e.g., a prompt) including instructions to an AI to suggest edits to the content of the page 600. The suggested edits can include suggesting edits to change style, tone, changing, adding or removing particular portions of text, generating new content, or any other changes to add, delete, or modify the content of the page 600.

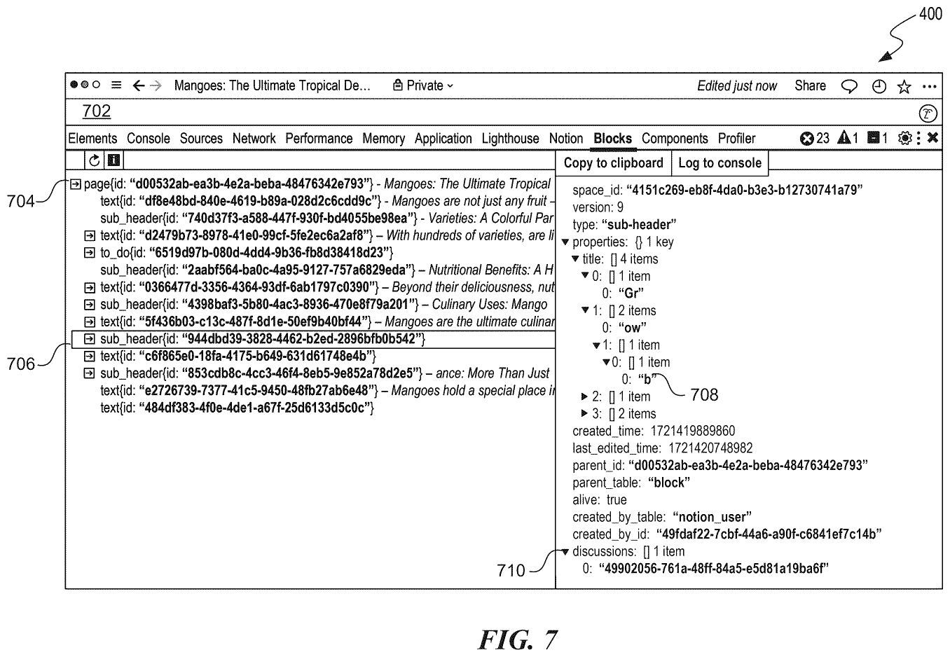

FIG. 7 illustrates a code page 702 associated with the page 600 stored in accordance with the block data model. The code page 702 includes code items that correspond to content of the page 600. For example, on the left side of the code page 702, a code portion 704 includes a unique identifier associated with the page block and lists under it different sub-blocks (e.g., content blocks, title blocks) that are included on the page 600. The code portion 706 is associated with the title block 608 in FIG. 6 and includes a unique identifier associated with the title block 608 (“sub_header{id: “944. . . ”}”). The right side of the code page 702 includes an expansion of the code associated with the code portion 706. As shown, the code portion 708 includes a property associated with the suggested edit 602 that is suggested to be bolded (indicated as “b”). The suggested edit 602 is thereby stored as a property of the title block 608. Further, the discussion section 606 of the suggestion card 604 in FIG. 6 is stored as a code portion 710 (“discussion”) also as a property of the title block 608.

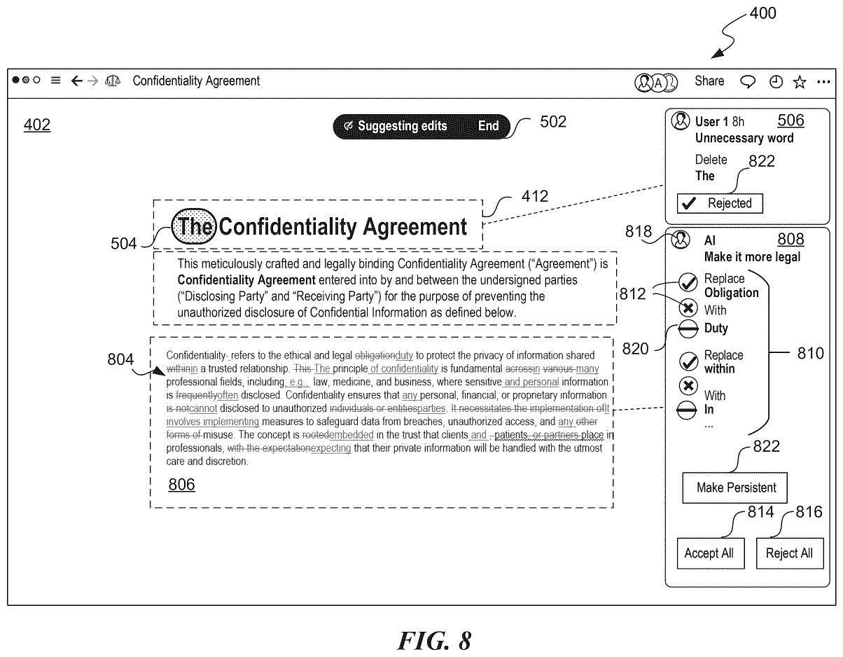

As described with respect to FIG. 6, in some implementations, the suggested edits can be provided by an integrated AI tool. As described above with respect to FIG. 4, the AI control element 404 can enable a user to open an integrated AI tool (e.g., the AI tool 104 in FIG. 1). AI-suggested edits can be provided in response to a prompt provided by a user (e.g., instructions provided on the prompt control element 616 of the AI tool 614 in FIG. 6). FIG. 8 illustrates a combination of suggested edits provided by a (human) user (e.g., the suggested edit 504 of the title block 412 by User 1) and AI (e.g., suggested edits 804 of the content block 806 by AI 818).

The suggested edits 504 are associated with the suggestion card 506. Here, a user has rejected the suggested edit 504 (e.g., by an input on the reject control element 511 in FIG. 5) to delete the word “The.” In FIG. 8, the rejected edit 504 on the word is illustrated with a patterned block highlighting the word “The” to indicate that there is a suggested edit associated with this word but the suggested edit has been rejected.

The AI-suggested edits 804 are associated with a suggestion card 808 which includes descriptions 810 associated with each of the edit suggestions on the content block 806. The suggestion card also includes an explanation or reasoning for the suggested edits of content block 806 (e.g., “Make it more legal”). The explanation or reasoning can be derived from the prompt provided by a user to create the suggested edits. For example, a user has provided a prompt input that is requesting the AI tool to edit the text of the block 806 to have a more legal tone or style. As shown, the suggestion card 808 includes control elements 812 that enable a user to reject or accept individual edits of the AI-suggested edits 804 as well as control elements 814 (e.g., an accept control element) and 816 (e.g., a reject control element) that enable a user to reject or accept all of the edits of the suggested edits 804.

In some instances, unlike suggested edits that are entered manually to a page by a user, suggested edits generated by an AI can be voluminous. As shown, the suggested edits 804 on the block 806 include a number of edits that can make the content of the block 806 to appear confusing and difficult to read. The system can be therefore configured to treat AI-suggested edits differently from suggested edits from a user. In some implementations, the suggested edits that are generated by AI are rendered as non-persistent edits on a page whereas the suggested edits by a user are persistent. This can mean that the suggested edits by a user are automatically stored as a property of the respective block while the AI-suggested edits are not automatically stored as properties of the respective block. Instead, a user would need to perform an additional action to make the edit persistent, such that an identifier of the suggested edit is stored as a property of the block that includes at least a portion of the suggested edit. In such implementation, the AI suggested edits 804 on the page 402 in FIG. 8 can correspond to a preview of suggested edits. As shown in FIG. 8, the suggestion card 808 associated with the AI-suggested edits 804 includes control elements 822 (for all) and 820 (for an individual edit) that enable a user to make the AI-suggested edits persistent. In response to a user input on the control elements 822 or 820, all or a single AI-suggested edit in the block 806 is stored as a property of the block 806.

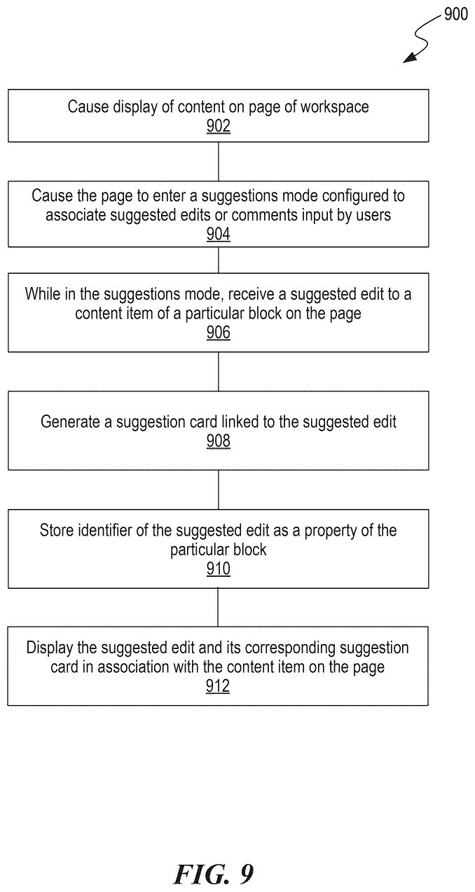

FIG. 9 is a flowchart illustrating a process 900 performed by a system to create suggested edits based on input from users of a workspace. The system supports real-time co-authoring including suggesting edits to a page of the workspace. The process 900 is performed by users who are authorized to edit blocks of the workspace such as the blocks embedded on a page of the workspace. The users who provide the suggested edits have a reviewer role or privileges.

At 902 the system causes display of content on a page of the workspace (e.g., the page 402 in FIG. 4). The content (e.g., text, images, or media) is structured in blocks (e.g., the title block 412 and the content block 414 in FIG. 4) that are associated with content items. The system stores the content items in accordance with a block data structure including multiple blocks, where each content item is associated with at least one of the multiple blocks. Further, each block has multiple properties that are custom attributes that describe the block, and each block has a type that determines how the block is displayed and how the multiple properties of the block are interpreted (e.g., FIG. 7). The blocks can include indications or identifiers of the content items included in the blocks. For example, FIG. 7 illustrates the code portion 704 associated with the page 600 including a unique identifier and the code portion 706 associated with the title block 608 includes a different unique identifier.

At 904, the page is set in a suggestions mode that enables for entering suggested edits for the content items (e.g., the page 402 is in the suggestion mode in FIG. 5 as indicated by the indicator 502). For example, a user can select the suggestions mode from the editing menu (e.g., the toolbar 406 in FIG. 4) to cause the page of the workspace to enter the suggestions mode. In the suggestions mode, the system allows suggested edits or comments input by members of the workspace, which are users authorized for the page. That is, the users have reviewer or editor roles or permissions. The system enables the creation of suggested edits from input by the member of the workspace, and/or enables generating suggested edits by the AI system.

At 906, in the suggestions mode, the system receives a suggested edit to a content item of a particular block on the page (e.g., the suggested edit 504 in FIG. 5). The authorized users of the workspace are enabled to add, modify, or delete suggested edits for the content item. The suggested edit can be presented as an inline edit (e.g., as the suggested edit 504) or a block-level edit of the block that includes at least a portion of the content item. For example, the user can move, edit, or delete a block that contains the content item. The page can include a display of a visual indication of a status of the suggested edit, where the status can be selected by the user from among the group of accepted, rejected, and pending review. For example, in FIG. 8, a user has rejected the suggested edit to delete the word “The” from title block 412 and the word “The” is highlighted with a patterned shape. Accepted, rejected, and pending suggested edits can be displayed with different visual indications (e.g., colors, patterns, font style/color/size, or surrounding shapes).

At 908, a suggestion card is generated and linked to the suggested edit (e.g., the suggestion card 506 is linked to the suggested edit 504 in FIG. 5). The suggestion card can be a graphical element that contains a description of the suggested edit. The description of the suggested edit can be automatically generated in response to the suggested edit input by the user. Further, the suggestion card can be augmented with a comment input by an authorized user. For example, the suggestion card 506 includes a comment by User 1 explaining that the suggested edit is performed because the word “The” is an “Unnecessary word.” The comment can augment the suggested edit, which can be stored in association with the block that includes at least a portion of the content item associated with the suggested edit. The content of the suggestion card is integrated with a discussion data model that is configured to manage and organize discussions, comments, and feedback input by users of the workspace. For example, the suggestion card 604 in FIG. 6 includes the discussion section 606 which is stored as a property of the block 608, shown by the code portion 710 in FIG. 7. That is, the suggestion card is part of the discussion and collaboration outside of the suggested edit, or even outside of the suggestions mode entirely.

At 910, an indication of the suggested edit (e.g., a unique identifier) is stored as a property of the block, which can store multiple block properties (e.g., as described with respect to FIG. 7). In one example, the suggested edit traverses two or more blocks and the identifier of the suggested edit is stored as a property of each of the two or more blocks. For example, the suggested edit 516 on the title block 518 and content block 520 in FIG. 5 is stored as a property of both of the blocks 520 and 518. Hence, the suggested edit to content items is displayed across the two or more blocks as a common suggested edit on the page, but different instances of the same unique identifier of the suggested edit are saved as properties of the blocks.

At 912, the suggested edit and its corresponding suggestion card are displayed alongside the content item on the page. Additionally, in one instance, the system incorporates a notification mechanism that informs workspace users about the suggested edit. This notification can alert users through email (e.g., the email template 132 in FIG. 1) or an in-app notification about new suggested edits or related comments.

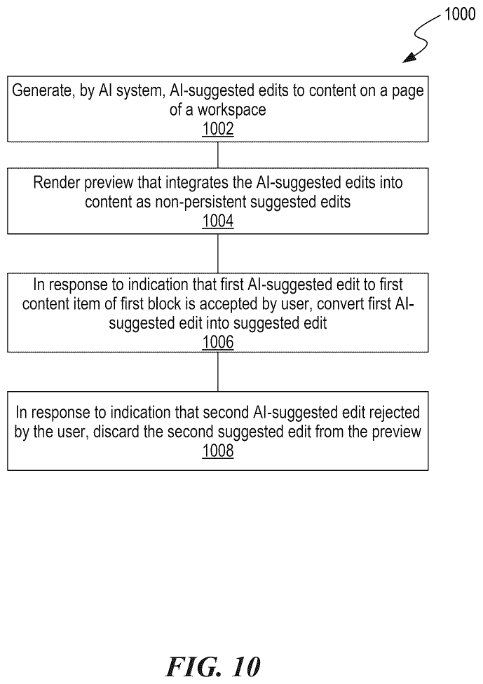

FIG. 10 is a flowchart illustrating a process 1000 that employs an AI system to generate suggested edits. This process 1000 facilitates real-time collaborative authoring, including edit suggestions from workspace users in addition to AI-suggested edits. Specifically, the suggestions mode allows authorized users to create user-initiated suggested edits, cause the system to generate AI-suggested edits, or both. In this mode, the system can accept user-suggested edits for content blocks on a page and record these edits as properties of those blocks. User-suggested edits are saved as persistent changes, whereas AI-suggested edits remain non-persistent and need user approval for acceptance or rejection. The system integrates both types of edits as inline or block-level changes in a unified preview.

At 1002, the system causes AI to generate suggested edits to content on the page of the workspace. The content is structured in blocks that are each associated with content items. For example, FIG. 8 includes the content block 806 including AI suggested edits 804. In one example, the AI system can generate a suggestion card linked to a particular AI-suggested edit (e.g., the suggestion card 808 is associated with the AI suggested edits 804 in FIG. 8). The suggestion card includes a description of the particular AI-suggested edit (e.g., “Make it more legal” in the suggestion card 808). The description is generated in response to the AI-suggested edit being generated or in response to the AI-suggested edit being accepted by the user. In one example, the suggestion card is augmented with a comment input by an authorized user of the workspace. For example, a user can comment on the AI suggested edit similar to the comments and/or discussion described with respect to FIG. 6. The comment is stored, along with an indication of the suggested edit, in association with the block that includes the content items associated with the suggested edit (e.g., as described with respect to FIG. 7). In an example, the content of the suggestion card is integrated with a discussion data model configured to manage and organize discussions, comments, and feedback input by users of the page within and outside of being in the suggestions mode.

In one example, the system can process content items of multiple blocks of a page and generate, using the AI system, multiple inline and block-level suggested edits to the content items of the multiple blocks. Examples of inline edits include deleting, adding, or moving text, images, or other media on a page. Examples of block-level edits include moving, editing, or deleting a block. The AI-suggested edits can be presented on the page using a diffing model as differences between original content items and suggested edits, where the differences are presented in a format different from the original content items.

At 1004, the system renders a visualization such as a preview that integrates the AI-suggested edits into the content on the page as non-persistent suggested edits. For example, the page 402 in FIG. 8 includes a preview of the suggested edits 804 provided by the AI tool. The AI-suggested edits are configured to be individually or collectively accepted or rejected by users of the workspace (e.g., by the control elements 814, 816, and 812).

In one example, a suggested edit traverses two or more blocks and the system stores, for each of the two or more blocks, an identifier of the suggested edit (e.g., as described with respect to FIG. 7) in each block that includes at least a portion of the content items associated with the suggested edit. As such, the suggested edit is displayed across the two or more blocks as a common suggested edit on the page, but instances of the identifier for the suggested edit are stored in respective ones of the two or more blocks.

At 1006, in response to an indication that an AI-suggested edit to a content item of a block is accepted by the user, the system converts the AI-suggested edit into a persistent suggested edit and stores an indication of the suggested edit as a property of the block including the content item and the suggested edit. For example, a user can make an AI suggested edit to be a persistent suggested edit by an input on the control element 820. A user can alternatively accept the AI suggested edit by an input on the accept control element 812 which causes the suggested edit to be persistent as well as have an accepted status. The system can cause display of a visual indication of a selectable status of the AI-suggested edits, where the status is selected by the system or the user as accepted, rejected, and pending review (e.g., as described with respect to the suggested edit 504 in FIG. 8). The system can optionally include a notification mechanism that is configured to send a notification indicative of the suggested edit to users of the workspace. The notification is sent via, for example, email (e.g., by the email template 134 in FIG. 1) or an in-app notification to alert the users of AI-suggested edits that have been accepted or associated comments.

At 1008, in response to an indication that an AI-suggested edit is rejected by a user (e.g., by an input on the reject control element of control elements 812 or the reject all control element 816), the system discards the suggested edit from the preview, where the discarded AI-suggested edit is irreversible. For example, the system discards the rejected AI-suggested edits when the page including the suggested edit is closed and the discarded suggested edits are permanently lost. The AI suggested edits are therefore treated differently from a user suggested edits. A rejected AI suggested edit is not stored as a property of a block while a rejected user suggested edit is stored as a property of the block.

### Computer System

FIG. 11 is a block diagram that illustrates an example of a computer system 1100 in which at least some operations described herein can be implemented. As shown, the computer system 1100 can include: one or more processors 1102, main memory 1106, non-volatile memory 1110, a network interface device 1112, a display device 1118, an input/output device 1120, a control device 1122 (e.g., keyboard and pointing device), a drive unit 1124 that includes a machine readable (storage) medium 1126, and a signal generation device 1130 that are communicatively connected to a bus 1116. The bus 1116 represents one or more physical buses and/or point-to-point connections that are connected by appropriate bridges, adapters, or controllers. Various common components (e.g., cache memory) are omitted from FIG. 11 for brevity. Instead, the computer system 1100 is intended to illustrate a hardware device on which components illustrated or described relative to the examples of the figures and any other components described in this specification can be implemented.

The computer system 1100 can take any suitable physical form. For example, the computer system 1100 can share a similar architecture as that of a server computer, personal computer (PC), tablet computer, mobile telephone, wearable electronic device, network-connected (“smart”) device (e.g., a television or home assistant device), AR/VR system (e.g., head-mounted display), or any electronic device capable of executing a set of instructions that specify action(s) to be taken by the computer system 1100. In some implementations, the computer system 1100 can be an embedded computer system, a system-on-chip (SOC), a single-board computer (SBC) system, or a distributed system such as a mesh of computer systems or include one or more cloud components in one or more networks. Where appropriate, one or more computer systems 1100 can perform operations in real time, near real time, or in batch mode.

The network interface device 1112 enables the computer system 1100 to mediate data in a network 1114 with an entity that is external to the computer system 1100 through any communication protocol supported by the computer system 1100 and the external entity. Examples of the network interface device 1112 include a network adapter card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 1106, non-volatile memory 1110, machine-readable medium 1126) can be local, remote, or distributed. Although shown as a single medium, the machine-readable medium 1126 can include multiple media (e.g., a centralized/distributed database and/or associated caches and servers) that store one or more sets of instructions 1128. The machine-readable medium 1126 can include any medium that is capable of storing, encoding, or carrying a set of instructions for execution by the computer system 1100. The machine-readable medium 1126 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 1110, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1104, 1108, 1128) set at various times in various memory and storage devices in computing device(s). When read and executed by the processor 1102, the instruction(s) cause the computer system 1100 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

1. A non-transitory, computer-readable storage medium comprising instructions recorded thereon, wherein the instructions, when executed by at least one data processor of a system, cause the system to:
cause display of content on a page of a workspace,
wherein the content is structured in multiple blocks that are each associated with one or more content items;
cause the page to enter a suggestions mode configured to associate suggested edits or comments input by users authorized for the workspace;
while in the suggestions mode:
receive a suggested edit to a content item of a particular block on the page, wherein the suggested edit is presented as an inline edit or a block-level edit of the particular block;
generate a suggestion card linked to the suggested edit, the suggestion card containing a description of the suggested edit,
wherein the description of the suggested edit is automatically generated in response to the suggested edit input by the user;
store an identifier of the suggested edit as a property of the particular block; and
cause display of the suggested edit and the suggestion card in association with the content item on the page.

2. The non-transitory, computer-readable storage medium of claim 1, wherein the system is further caused to:
augment the suggestion card with a comment input by an authorized user of the workspace; and
store the suggested edit and the comment in associate with the particular block.

3. The non-transitory, computer-readable storage medium of claim 1, wherein the suggested edit traverses two or more blocks including the particular block, the system being further caused to:
store, for each of the two or more blocks, a property value including the identifier of the suggested edit; and
cause display of the suggested edit across the two or more blocks as a common suggested edit on the page.

4. The non-transitory, computer-readable storage medium of claim 1, wherein the system is further caused to:
cause display of a visual indication of a status of the suggested edit, wherein the status is selected by the user from the group consisting of:
accepted,
rejected, and
pending.

5. The non-transitory, computer-readable storage medium of claim 1, wherein the system is further caused to:
send a notification indicative of the suggested edit to one or more of the users of the workspace,
wherein the notification is configured to alert users via email or an in-app of new suggested edits or associated comments notification.

6. The non-transitory, computer-readable storage medium of claim 1:
wherein the content on the page includes text, images, or media, and
wherein the block-level edit includes to move, edit, or delete the particular block.

7. The non-transitory, computer-readable storage medium of claim 1, wherein the system is further caused to:
integrate content of the suggestion card with a discussion data model configured to manage and organize discussions, comments, and feedback input by users of the page.

8. The non-transitory, computer-readable storage medium of claim 1, wherein the system supports real-time co-authoring of suggested edits by the users authorized for the page.

9. The non-transitory, computer-readable storage medium of claim 1, wherein the system is further caused to:
enable creation of the suggested edit as input by a user authorized as a member of the workspace.

10. The non-transitory, computer-readable storage medium of claim 1, wherein the system is further caused to:
enable generation of the suggested edit by an artificial intelligence (AI) system.

11. A system comprising:
at least one hardware processor; and
at least one non-transitory memory storing instructions, which, when executed by the at least one hardware processor, cause the system to:
store content including one or more content items in accordance with a block data structure including multiple blocks,
wherein each content is associated with at least one of the multiple blocks,
wherein each block has multiple properties that are custom attributes that describe the block, and
wherein each block has a type that determines how the block is displayed and how the multiple properties of the block are interpreted;
set a suggestions mode configured to enable users to add, modify, or delete suggested edits for the one or more content items;
receive a suggested edit to a particular content item of a particular block of the workspace,
wherein the suggested edit is configured as an inline edit or a block-level edit of the particular block;
automatically generate, in response to the suggested edit, a description of the suggested edit;
associate the suggested edit with a suggestion identifier; and
store the suggested identifier as a property of the multiple properties of the particular block.

12. The system of claim 11 further caused to:
incorporate the description of the suggested edit in a container that is linked to the suggested edit;
augment the container with a comment input by a user of the workspace; and
store the suggested edit and the comment in associate with the particular block.

13. The system of claim 11, wherein the suggested edit traverses multiple blocks including the particular block, the system being further caused to:
store the suggestion identifier of the suggested edit as a property of each of the two or more blocks; and
store the suggested edit as a common suggested edit configured for display across the two or more blocks.

14. The system of claim 11 further caused to:
enable designation of a status of the suggested edit in response to user input,
wherein the status includes:
accepted,
rejected, and
pending.

15. The system of claim 11 further caused to:
notify users of the workspace about the suggested edit via email or in-app.

16. The system of claim 11:
wherein the content includes text, images, or media, and
wherein the block-level edit includes to move, edit, or delete the particular block.

17. The system of claim 11 further caused to:
integrate the description of the suggested edit with a discussion data model configured to manage and organize discussions, comments, and feedback created outside of the suggestions mode.

18. A method performed on a page of a workspace, the method comprising:
structuring content items in multiple blocks of the page of the workspace;
activating a suggestions mode for the page configured to associate suggested edits to the content items;
receiving a suggested edit for a content item of a particular block on the page,
wherein the suggested edit has an identifier configured to store as a property of the particular block;
in response to the suggested edit, automatically generating a description of the suggested edit; and
storing the suggested identifier and the description of the suggested edit in association with the particular block.

19. The method of claim 18 further comprising:
causing display of the suggested edit and the description of the suggested in association with the content item on the page.

20. The method of claim 18 further comprising:
causing display of the suggested edit as an inline edit or a block-level edit of the particular block.
